(19) United States
(12) Patent Application Publication
(10) Pub. No.: US 2018/0359353 A1
(43) Pub. Date: Dec. 13, 2018

(54) FOLDER MANAGEMENT SYSTEM FOR INSTANT MESSAGING ON MOBILE COMMUNICATION DEVICES

(71) Applicants: Claude Vlandis, Bay Harbor Islands, FL (US); Vanessa Vlandis, Bay Harbor Islands, FL (US)

(72) Inventors: Claude Vlandis, Bay Harbor Islands, FL (US); Vanessa Vlandis, Bay Harbor Islands, FL (US)

(21) Appl. No.: 15/618,218

(22) Filed: Jun. 9, 2017

(51) Int. Cl. H04M 1/725; H04L 12/58

(52) U.S. Cl. CPC H04M 1/72552; H04L 51/38; H04L 51/22; H04L 51/04

(57) ABSTRACT

The embodiments disclosed provide a folder management system for categorizing instant messages using a mobile communication device. The system includes an integrated processor which enables the user to create a plurality of new categorized folder and “drop and drag” a selected instant message into a selected categorized folder using a graphical user interface (GUI). The system further provides a visual notification to the user when a new instant message is received with one of the plurality of categorized folders created. Further, the system enables the user to transition between categorized folders by depressing the GUI which provides a list of all chronologically received messages.

### CROSS-REFERENCE TO RELATED APPLICATION

This application claims the benefit of provisional patent application No. 62/484,487 filed on Apr. 24, 2017 titled “A Folder Management System for Online Message and Method of Use” by the present inventors.

### FIELD

The present embodiments disclose a folder management system, and in particular, a user interface for processing, generating, and storing instant messages within a user defined folder management system.

### BACKGROUND

Instant messaging is a popular form of “chatting” and collaborating in real-time over a network data processing system. Instant messaging enables the user to communicate over the internet using a variety of windows which may also show other users' availability and provide an indication when a specified user has logged-in and is available to chat. These short bi-directional communications have been become a primary means of communication for business and personal use and have replaced traditional chat rooms. Many text messaging platforms have expanded to incorporate push technology, Voice over IP, video chat, and file transfers.

Traditional instant messaging systems only include a default folder for storing messages and required to the user to review all archived messages before finding the specific chat session. As these chat sessions, stored files, and threads become more voluminous, the challenge of organizing these multiple sessions quickly increases.

Conversely, electronic mail is much easier to store, process, and categorize, and often incorporates a search function and folder management which may then be further defined by the user; however, current messaging platforms fails to provide real-time communication and is often compromised by hackers.

Currently there are several systems and methods which disclose aspects of storing and categorizing electronic communications such as U.S. App. Pat. No. 2008/0281933 to Boss; U.S. Pat. No. 8,001,184 to IBM; and U.S. Pat. App. No. 2007/0180040 to Etgen. However, these references do not enable the user to drop and drag received messages in categorized and uncategorized folders while automatically placing subsequent messages within the selected folder.

### SUMMARY OF THE INVENTION

The present embodiments provide a folder management system for organizing instant messaging “chat sessions” and threads. The system which includes a Graphical User Interface (GUI) allows the user to depress a selectable button and create a plurality of categorized folders which appear in consecutive rows above the received messages. The integrated processor further enables all subsequent messages from the same source to be automatically placed into the categorized folder upon receipt once a categorized folder has been created. In addition, the system provides a visual notification to the user when a new message has been received within the categorized or uncategorized folder by providing an illuminated light emitting diode within a top portion of the categorized folder. Transitioning between a conversation and a categorized folder is achieved by depressing the desired categorized folder which subsequently displays a visual indicator along the bottom portion of the folder.

The embodiments further provide a method of implementing the above-mentioned system including displaying at least one categorized folder on the GUI, providing visual notification to a user when a received message is recorded; enabling a user to select a categorized folder and then drop and drag a desired instant message within the categorized folder; and automatically placing any subsequent messages from the same source within the selected categorized folder upon receipt.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1A is an exemplary view of a folder management system for instant messaging on mobile communication devices;

FIG. 1B is an alternative view of the system including a plurality of categorized folders;

FIG. 2 is a block diagram of the system including one method of implementation;

FIG. 3 is a further block diagram illustrating an alternative method of implementing the folder management system;

FIG. 4 is a flowchart illustrating a method of categorizing a received instant message within a categorized folder;

FIG. 5 is an alternative flowchart illustrating a method of removing a duplicate message; and

FIG. 6 is a further alternative flowchart illustrating one method categorizing a received message within a categorized folder.

### DETAILED DESCRIPTION

Before describing in detail exemplary embodiments, it is noted that the embodiments reside primarily in combinations of apparatus components and processing steps related to categorizing messages in a messaging system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Embodiments include a messaging system that enables automatic categorization of incoming messages from a particular source based on a categorization of the particular source selected by a user of the messaging system.

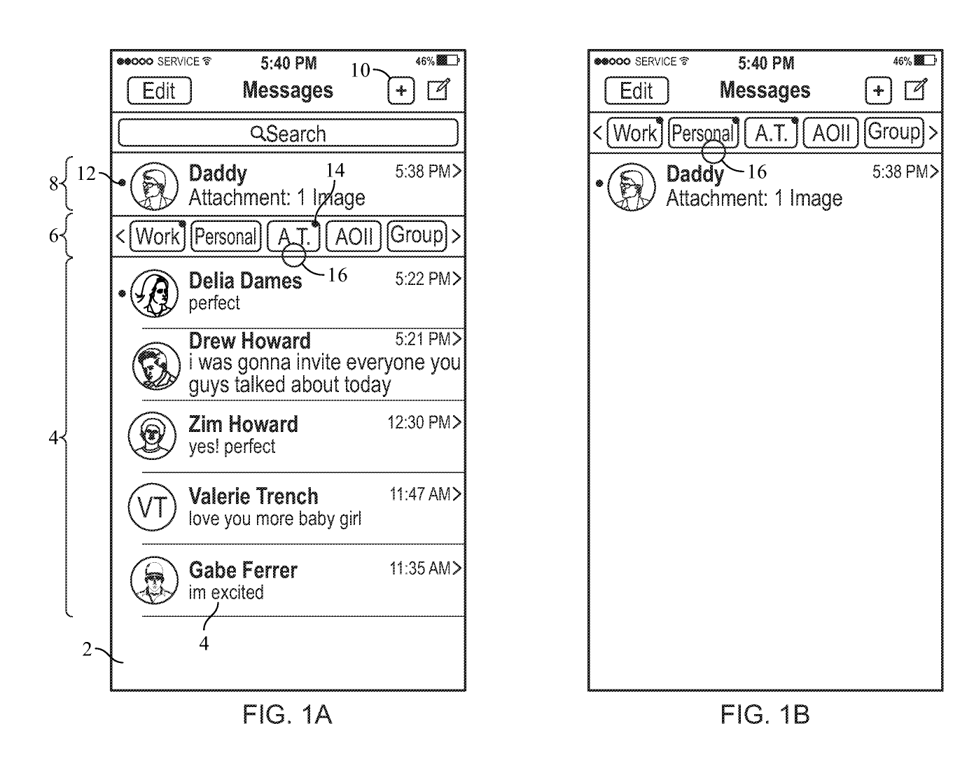

FIG. 1A shows an exemplary display of a message panel 2 that shows a list 4 of incoming messages in a column illustrating the source (name of the person from whom the message is received) of each message and at least part of the text of the message for each message. In this particular example, the list 4 has the names, “Delia Dames, Drew Howard, Zim Howard, Valerie Trench and Gabe Ferrer.”

At the top of the list 4 of incoming messages is a row of categories 6. Each category has a different name given by the owner of the message program or other user. In this particular example, the categories are, “work, personal, A.T., AOII, and Group.” Note that more categories may exist and their names may be made visible by scrolling the category list 6 to the left or to the right.

Above the list of categories 6 is an incoming message 8 from “Daddy” which has been received and has not yet been placed in a category. The user, using a mouse, may point to the text message labeled “Daddy” and click on it and drag it to a particular one of the categories 6, and release or drop the email into the category. Once this is done, messages from “Daddy” received in the future may automatically be placed in the selected category. Note that a message can be placed in more than one category at a time. Also, as will be explained below, messages may be categorized according to subject as entered into a subject field of the message. Thus, the same functionality as described herein for automatically categorizing according to message source can be applied for automatically categorizing according to message subject.

Categories can be added by pressing a button 10 which enable a user to type in the name of the new category. Note also that a dot 12 may mark messages that have not been read. Similarly, a dot 14 may mark a category which holds new messages that have not been read. Also, a small arrow 16 may point to the current category whose contents are currently being displayed. In this particular example, the arrow 16 points to the category “A.T.,” and consequently, the messages in this category are listed in the list 4.

FIG. 1B shows the display of incoming messages when the “personal” category is selected, showing that only the message from “Daddy” is in this category. A category is selected by placing a pointer over the category button and clicking on the button.

Note that in some embodiments, a category button named “ALL” may be displayed that when selected displays a list of all messages of all categories. Placing a cursor on the “ALL” button and holding the mouse button for a few seconds, an “UNCAT” button is displayed that when subsequently selected, causes a list of all uncategorized messages to be displayed.

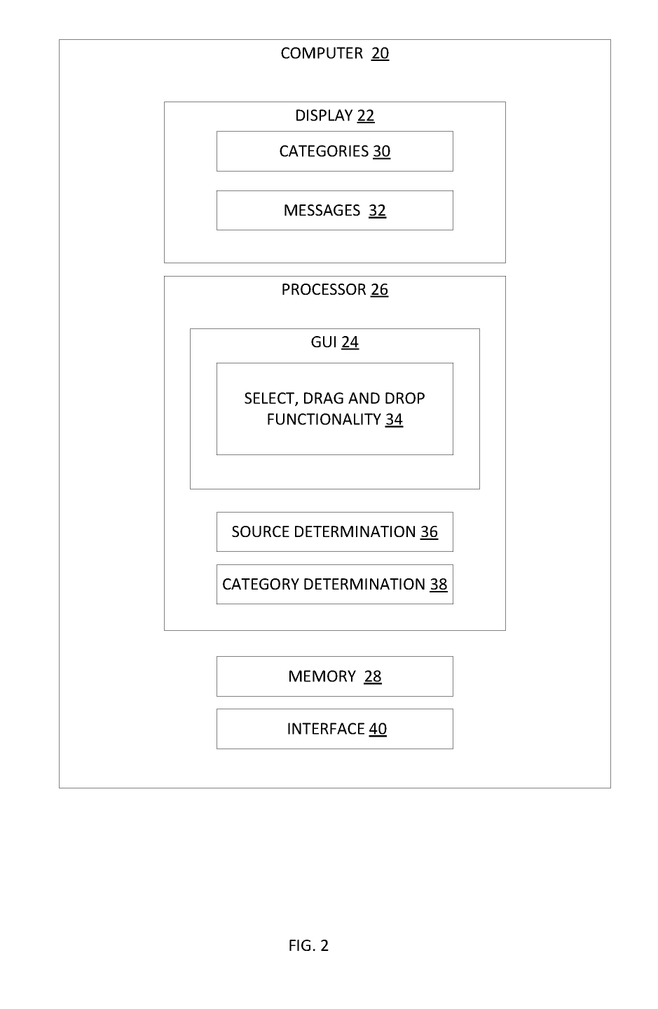

FIG. 2 is block diagram of a computer 20 configured to implement the messaging program described above. The computer has a display 22, a graphical user interface (GUI) 24 implemented by a processor 26, a memory 28, and an interface 40. The memory 28 may store software instructions that, when executed by the processor 26, cause the processor 26 to perform the functions and acts described above. In particular, the display 22 operating under the control of the processor 26, displays the categories 30 and the messages 32. The processor 26 also implements the GUI 24 which provides select, drag and drop functionality 34 to pull incoming messages into a category, to enable selection of a category and to create new categories. The processor 26 also implements source determination functionality 36 to identify the source of an incoming message. The category determination functionality 38 of the processor 26 determines a category to which an incoming message belongs based on the source identity. The interface 40 may interface the messaging categorization functionality with an existing messaging program such as Microsoft Outlook®.

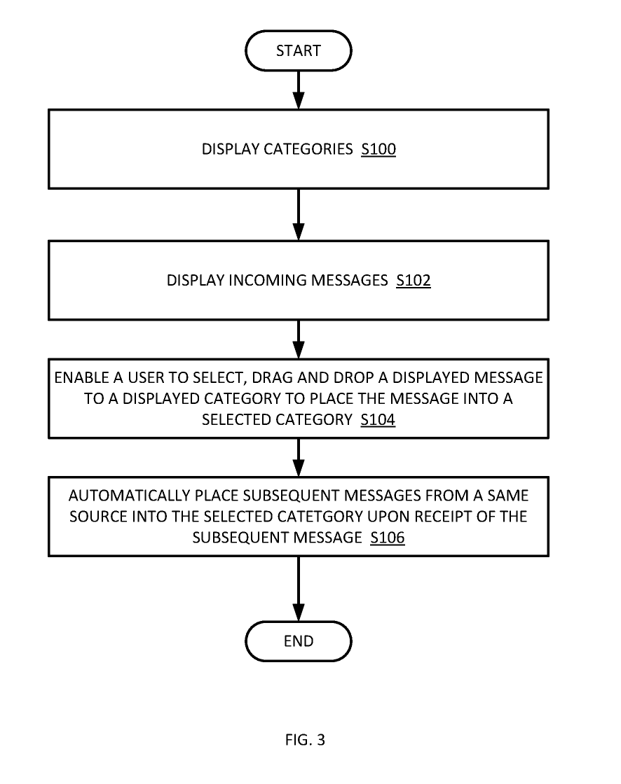

FIG. 3 is a flowchart of an exemplary process for categorizing messages in a message program. The process includes displaying categories (block S100) and displaying incoming messages (block S102). The process includes enabling a user to select, drag and drop a displayed message into a displayed category to place the message in the selected category (block S104). The process also includes automatically placing subsequent messages from a same source as a previous message into the same category of the previous message of the same source (block S106).

In some embodiments, a computer program product stored on a tangible computer-readable medium such as a compact disc, for example, has computer program code embodied in the medium that can be executed by the computer to cause the computer to display categories, display incoming messages, and to enable a user to select, drag and drop a displayed message to a displayed category to place the messaged into a selected category. The computer is also caused to automatically place subsequent messages from a same source into the selected category upon receipt of the subsequent message.

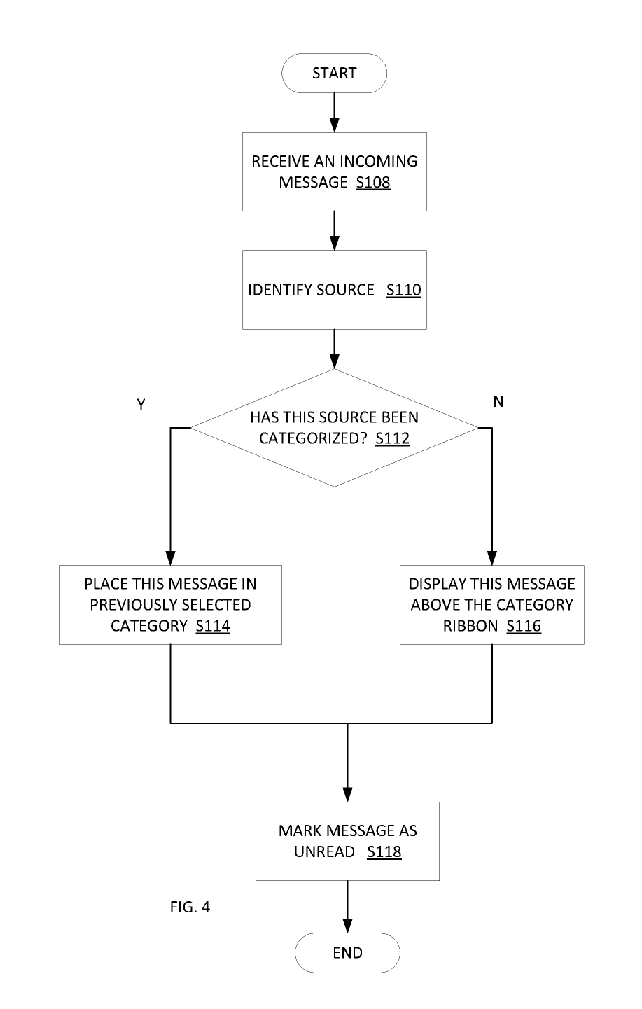

FIG. 4 is a flowchart of an exemplary process for automatically categorizing a previously categorized source. The process includes receiving an incoming message (block S108). The source of the incoming message is identified (block S110). A determination is made whether the identified source has previously been categorized (block S112). If so, the message is placed in the previously selected category (block S114). If not, the message is displayed above the category ribbon (block S116). In either case, the message is marked as unread (block S118).

Note that embodiments can interface with preexisting text message programs such as Microsoft Outlook® to add the functionality described above to the preexisting messaging program. Thus, an embodiment of message categorization code having the functionality described herein can be stored on a disc and inserted into a disc reader and loaded onto a computer that already has messaging software stored thereon. The message categorization program as described above may interact with the preexisting messaging program to cause a display of categories at a top of the usual display of the preexisting messaging program, and will enable the user to select and drop messages from a message list into a category as described above.

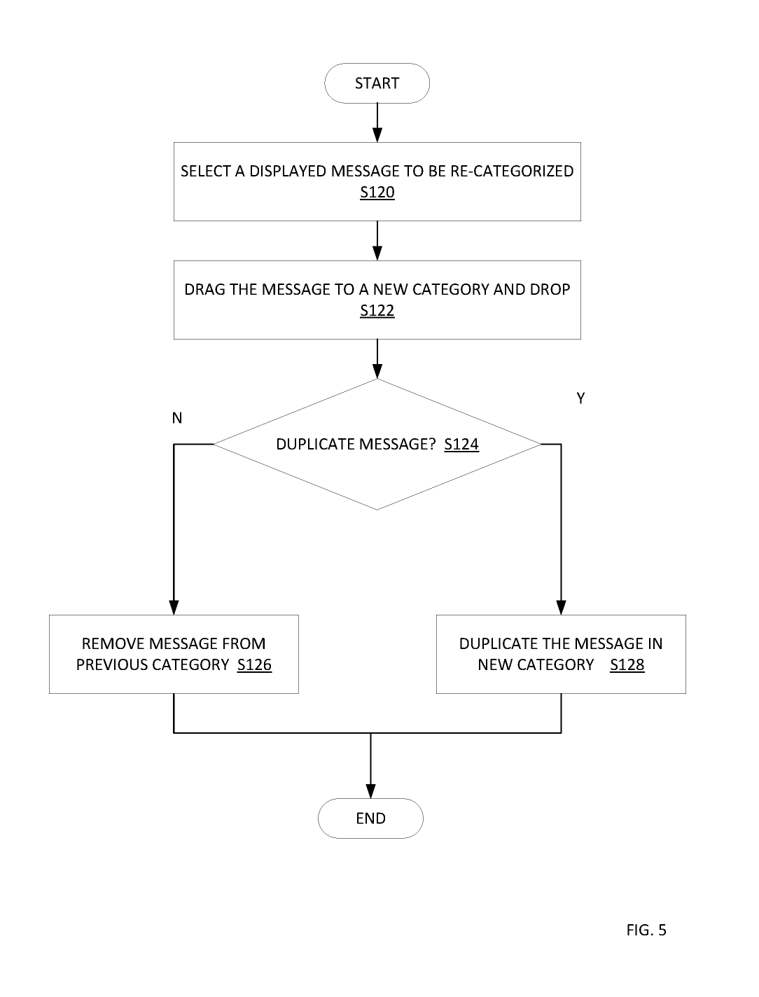

In some embodiments, a sort function is provided to enable the user to sort the ribbon of categories to be displayed in a preferred order. In some embodiments, via a sub-category creation button, sub categories may be created, displayed and selected. In some embodiments, a user may select whether messages from a particular source are to be automatically placed in a category or not. Further, in some embodiments, a message can be re-categorized by selecting the message, dragging it to a different category and dropping the message into a new category. This is shown in FIG. 5.

FIG. 5 is a flowchart of an exemplary process for re-categorizing a message that has previously been categorized and placed in a new category. The process includes a user selecting a message to be re-categorized (block S120). A user then drags and drops the selected message into the new category (block S122). A determination is made whether the message is to be duplicated in the new category or moved to the new category from the old category (block S124). This option may be selected by the user via the GUI 24 that displays switch and enables selection of the switch. If the message is not to be duplicated but rather the message is removed from the original category and placed in the new category (block S126). Otherwise, the message is duplicated and placed in the new category while leaving a copy of the message in the original category (block S128). If duplication is selected, future messages from the same source may also be automatically duplicated and placed in each of the original and new categories.

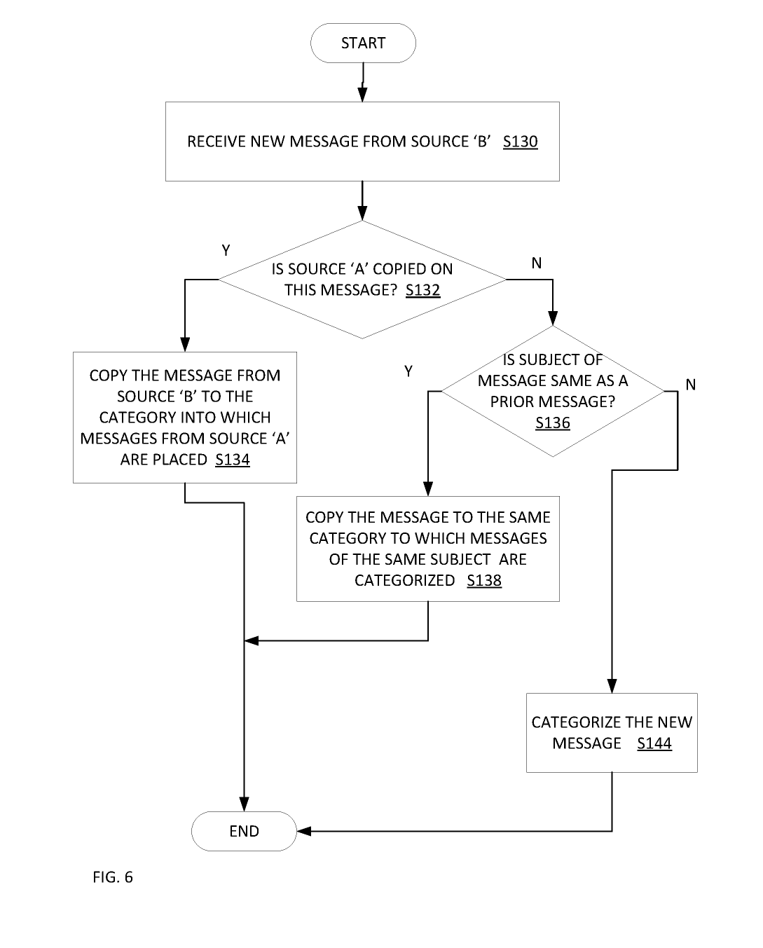

In some embodiments, not only are messages from the same source automatically placed in the same category as previous messages from that source, but messages belonging to a same conversation thread may be automatically placed in the same category. Thus, for example, replies to a message from a particular source may also be automatically placed in the category into which the messages from the source have been placed. Also, messages received from a second source that are also copied by the sender to a first source may be placed automatically in the category to which messages from the first source are placed. In addition, or in the alternative, messages can be categorized by subject of the message entered into a subject field of the message. These features are shown in FIG. 6.

FIG. 6 is a flowchart of an exemplary process for categorizing messages received from a source B that is different from a previous source A but related to messages received from the previous source A. The process includes receiving a new message from a source B (block S130). A determination is made whether source A is in a message source field of the message (block S132). If so, the message is copied into the category into which messages from source A are placed (block S134). Otherwise, a determination is made whether the subject of the new message is the same as a subject of a prior message that has been categorized already (block S136). Of so, the new message is automatically copied or moved to the same category into which messages of the same subject are placed (block S138). Otherwise, the message may optionally be categorized by the user (block S144). Thus, embodiments may include categorizing messages by source or by subject or by both source and subject.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method of categorizing incoming messages on an electronic device, the method comprising:
displaying categories;
displaying incoming messages;
enabling a user to select, drag and drop a displayed message to a displayed category to place the message into a selected category; and
automatically placing subsequent messages from a same source into the selected category upon receipt of the subsequent message.

2. The method of claim 1, further comprising displaying a selectable button that when selected, creates a new category to be titled by the user.

3. The method of claim 1, further comprising displaying a selectable button that when selected causes display of uncategorized messages.

4. The method of claim 1, further comprising displaying all received messages in a category by selecting the category.

5. The method of claim 1, wherein the displayed categories are displayed in a row that may be scrolled left and right.

6. The method of claim 1, wherein one category, when selected, causes display of all messages in all categories and all uncategorized messages.

7. The method of claim 1, wherein a message may be assigned to more than one category simultaneously.

8. The method of claim 1, wherein a step of automatically placing subsequent messages from the same source into the selected category upon receipt of the subsequent message is at an option of the user.

9. A message display and organizing system, the system comprising:
a display configured to display categories and messages;
a processor configured to:
implement a graphical user interface (GUI) to enable a user to select, drag and drop a displayed message to a displayed category to place the message into a selected category; and
automatically place subsequent messages from a same source into the selected category upon receipt of the subsequent message.

10. The system of claim 9, wherein the display is further configured to display a selectable button that when selected via the GUI, creates a new category to be titled by the user.

11. The system of claim 9, wherein the display is further configured to display a selectable button that when selected via the GUI, causes display of uncategorized messages.

12. The system of claim 9, wherein the display is further configured to display all received messages in a category by selecting the category.

13. The system of claim 9, wherein the displayed categories are displayed in a row that may be scrolled left and right.

14. The system of claim 9, wherein one category, when selected via the GUI, causes display of all messages in all categories and all uncategorized messages.

15. The system of claim 9, wherein a message may be assigned by the processor to more than one category simultaneously.

16. The system of claim 9, wherein a step of automatically placing subsequent messages from the same source into the selected category upon receipt of the subsequent message is at an option of the user.

17. A computer program product on a tangible computer-readable storage medium having computer program code embodied in the medium that can be executed by a computer to cause the computer to:
display categories;
display incoming messages;
enable a user to select, drag and drop a displayed message to a displayed category to place the message into a selected category; and
automatically place subsequent messages from a same source into the selected category upon receipt of the subsequent message.

18. The computer program product of claim 17, wherein the computer program code causes the computer to display a selectable button that when selected, creates a new category to be titled by the user.

19. The computer program product of claim 17, wherein the computer program code causes the computer to display a selectable button that when selected causes display of uncategorized messages.

20. The computer program product of claim 17, wherein the computer program code causes the computer to display all received messages in a category upon selection of the category.
